(19) United States
(12) Patent Application Publication
(10) Pub. No.: US 2013/0084227 A1
(43) Pub. Date: Apr. 4, 2013

(54) HEAT BLOCK WITH INSULATING COLLAR

(71) Applicants: RUSSELL W. COLE, Colmar, PA (US); Joseph M. Rock, Greenville, PA (US); Edward J. Staehle, JR., Telford, PA (US)

(72) Inventors: RUSSELL W. COLE, Colmar, PA (US); Joseph M. Rock, Greenville, PA (US); Edward J. Staehle, JR., Telford, PA (US)

(21) Appl. No.: 13/629,853

(22) Filed: Sep. 28, 2012

Related U.S. Application Data
(60) Provisional application No. 61/541,502, filed on Sep. 30, 2011.

(51) Int. Cl. B01L 9/06

(52) U.S. Cl. 422/562

(57) ABSTRACT

A heat block with an insulating collar for use in thawing frozen cells and viruses for vaccine production.

### FIELD OF THE INVENTION

The present invention relates to an apparatus, comprising a heat block for heating a plurality of tubes containing samples of material. More particularly, this invention is directed to an apparatus for thawing frozen cells and viruses contained in 5 milliliter cryovials.

### BACKGROUND OF THE INVENTION

Temperature controlled water baths are commonly used to thaw frozen cell lines or viruses used in the manufacture of vaccines. These water baths are far from being optimal for the manufacturing process, as they present such problems as corrosion due to cleaning chemicals, inconsistent performance in environmental testing, high use of power and risks of contamination and compromised sterility. For these reasons, waterless heating is more desirable in the vaccine manufacturing context.

However, standard heating blocks do not accommodate the 5 milliliter cryovials typically used in vaccine production. In these blocks, this results in only the lower half of the cryovial being heated. An uneven thaw results, as the upper half of the vial remains frozen. It is therefore desirable to have a heat block for use in a waterless heating apparatus that would encompass the entire length of the vial, thereby creating an even thaw.

### SUMMARY OF THE INVENTION

The present invention relates to an apparatus for heating a plurality of tubes containing samples of material. The apparatus of the present invention, comprises a heat block having a plurality of wells adapted to receive tubes containing samples of material and a bore adapted to receive a thermocouple; and an insulating collar. The apparatus is placed into a standard dry block heater, connected to a thermocouple by means of a hole located in the heat block, and set to a particular temperature. Sample tubes containing material to be heated, such as frozen cells or viruses, are then placed into the wells of the apparatus for heating. The resultant even warming of the entire sample tube is achieved without any of the problems that may be encountered with a temperature controlled water bath (e.g., sterility, corrosion and high energy usage).

### BRIEF DESCRIPTION OF THE DRAWINGS

FIG. 1 shows a twenty well apparatus of the present invention.

FIG. 2 shows a top view of the apparatus of the present invention.

FIG. 3 shows a bottom view of the apparatus of the present invention.

FIG. 4 shows a cross section a well of the heat block of the present invention.

FIG. 5 shows a standard heat block of the prior art.

FIG. 6 shows an apparatus of the present invention used as intended with a standard dry block heater.

FIG. 7 shows a one well apparatus of the present invention.

FIG. 8 shows a five well apparatus of the present invention.

### DETAILED DESCRIPTION OF THE INVENTION

The apparatus of the present invention comprises a heat block having a plurality of wells adapted to receive tubes containing samples of material and a bore adapted to receive a thermocouple; and an insulating collar.

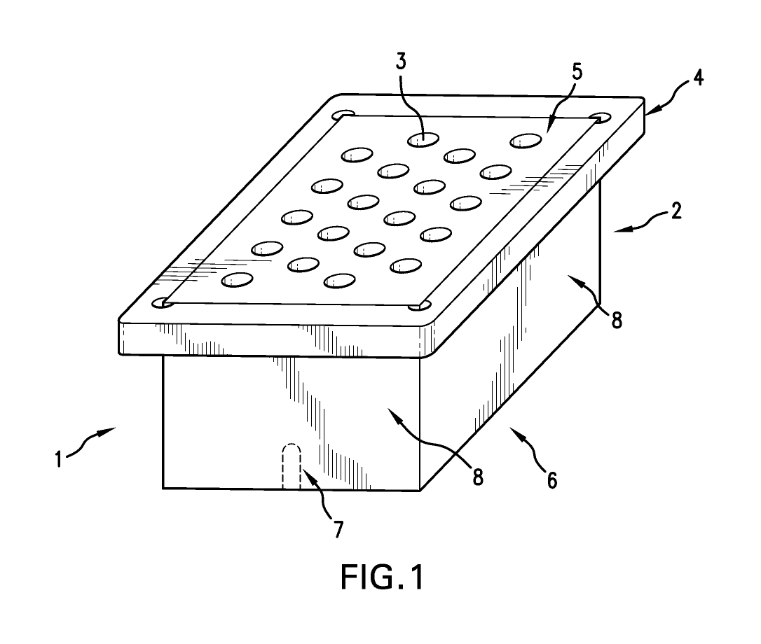

FIG. 1 illustrates an embodiment of the present invention. With reference to the drawing, the apparatus 1 comprises a heat block 2 comprising a heat conductive material, twenty wells 3 arranged in four staggered rows of five on the top surface 5 of the heat block 2 to allow for the maximum amount of conductive material between each well 3 to maximize the heat transfer between the heat block and the tubes containing the material, a bore 7 adapted for a thermocouple on the bottom surface 6 and an insulating collar 4 surrounding a portion of the sides 8.

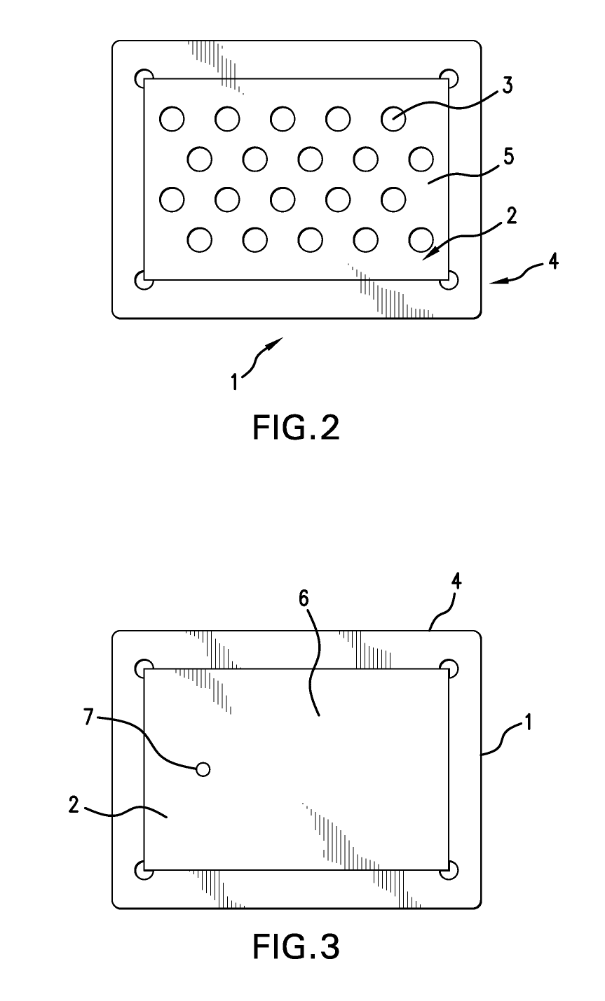

FIGS. 2 and 3 show the top and bottom views of the apparatus of the present invention. The top view in FIG. 2 depicts the twenty wells 3 arranged in four staggered rows of five on the top surface 5. Surrounding the heat block 2 is the insulating collar 4. The bottom view in FIG. 3 depicts the bottom surface 6 of the heat block 2 which includes a bore 7 adapted for a thermocouple.

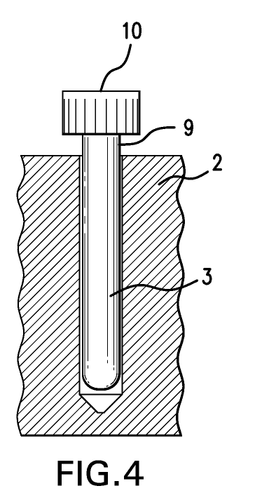

FIG. 4 shows a cross section of a well 3 in the heat block 2. The well 3 is extends into the heat block 2 at a sufficient length to accommodate substantially all of a 5 milliliter cryovial 9 without touching the cap 10 of the cryovial. The end of the well 3 is cone-like in shape so that when the cryovial 9 is inserted into the well, the bottom of the cryovial 9 does not touch the touch the end of the well 3.

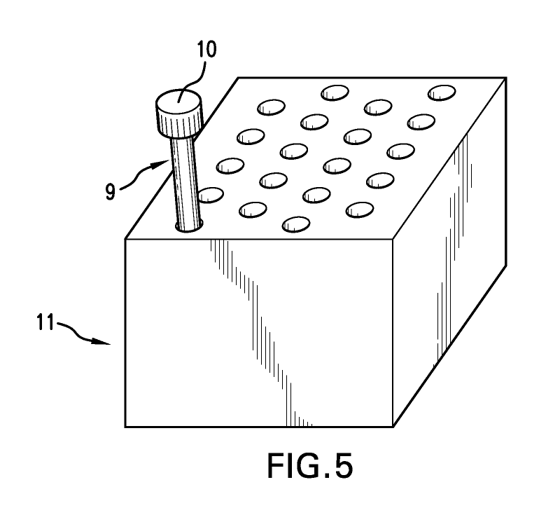

FIGS. 5 show a standard heat block 11 that is commercially available. As shown in FIG. 5, the standard heat block 11 covers approximately half of the surface of a standard 5 milliliter cryovial 9. Therefore, when a full cryovial 9 containing frozen material is heated, the material in the exposed section of the cryovial 9 is unthawed leaving a plug. The cross section of the well depicted in FIG. 4 shows that the well 3 covers a substantial portion of the cryovial 9 without touching the cap 10 of the cryovial 9. Therefore, even thawing is accomplished without contamination of the cap 10 of the cryovial 9.

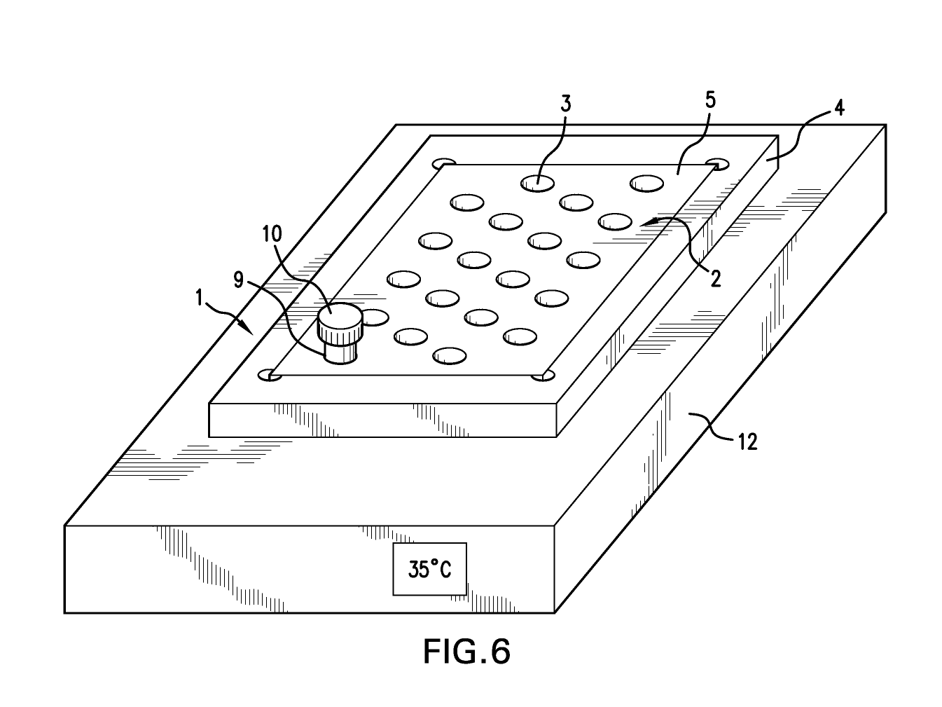

FIG. 6 depicts the apparatus 1 of the present invention with a 5 milliliter cryovial 9 used as intended with a standard dry block heater 12. When the heat block 2 is inserted into the heating compartment of the dry block heater 12, a portion of the heat block 2 is exposed. The insulating collar 4 insulates the exposed sides of the heat block 2 preventing heat loss. A thermocouple projects from the bottom of the heating compartment which fits into the bore 7 of the heat block 2 (not shown).

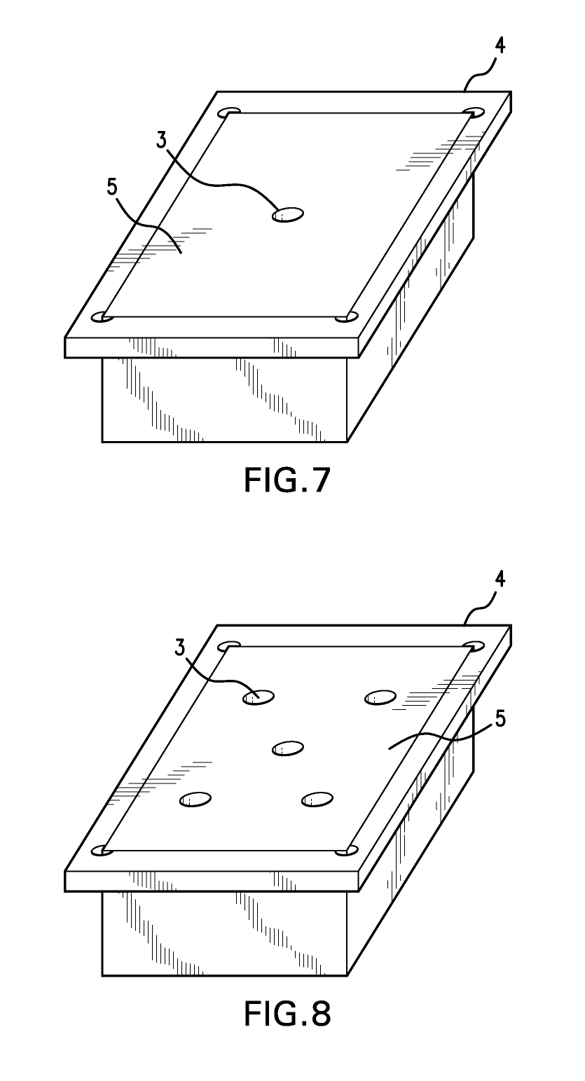

FIGS. 7 and 8 illustrates alternative embodiments of the present invention having one well 3 and five wells 3 in the center of the top surface 5 of the heat block 2. In the drawings, the wells 3 are arranged to maximize the heat transfer.

The heat block depicted in FIG. 1 shows the heat block 2 in a rectangular shape for the purpose of fitting into standard dry block heaters. However, the heat block can be machined, molded, extruded, or cast into other suitable shapes by one skilled in the art.

In one embodiment of the present invention, the heat block has a length of about 10 to 25 centimeters, a width of about 5 to about 20 centimeters, and a height of about 5 to 15 centimeters. In one class of this embodiment, the heat block has a length of about 15.16 centimeters, a width of about 9.76 centimeters, and a height of about 8.26 centimeters.

The heat block can be made from any heat conductive material. However, the preferred conductive material depends upon the specific application.

In one embodiment of the present invention, the heat block comprises a heat conductive material selected from the group consisting of copper, titanium, heat conductive ceramics, heat conductive plastics, nickel, iron, aluminum and metal alloys. In one class of this embodiment, the metal alloy is an aluminum alloy. In one class of this embodiment, the metal alloy comprises about 94.0 to 99.0 weight percent aluminum, about 0.5 to 2.0 weight percent magnesium, about 0.01 to 0.5 weight percent chromium, about 0.05 to 0.5 weight percent copper, and about 0.05 to 1.0 weight percent silicon. In one subclass of this class, the metal alloy is aluminum 6061.

In one embodiment of the present invention, the heat block can have from one to twenty wells. In a class of this embodiment, the heat block can have one well, five wells or twenty wells. In a class of this embodiment, the heat block has one well. In a class of this embodiment, the heat block has five wells. In another class of this embodiment, the heat block has twenty wells.

In one embodiment of the present invention, the heat block has one well which is placed in the center of the top surface of the heat block.

In one embodiment of the present invention, the heat block has five wells that are arranged on the top surface of the heat block to allow for the maximum amount of conductive material between each well to maximize the heat transfer between the heat block and the tubes containing the material.

In one class of this embodiment, the heat block has five wells, and the wells are arranged on the top surface of the heat block in three rows, wherein one row has one well which is placed in the center of the top surface of the heat block, and wherein the other two rows each have two wells which are spaced about 10.75 centimeters, and wherein each of the wells in the other two rows are spaced by about 4.9 centimeters from the well in the center.

In one embodiment of the present invention, the heat block has twenty wells that are arranged on the top surface of the heat block to allow for the maximum amount of conductive material between each well to maximize the heat transfer between the heat block and the tubes containing the material.

In one class of this embodiment, the heat block has twenty wells, and the wells are arranged on the top surface of the heat block in four staggered rows of five, wherein the space between each well within each row is about 1.3 centimeter, and wherein the space between each well and the nearest well in an adjacent row is about 2.24 centimeters.

In one embodiment of the present invention, the wells have a diameter of about 1.0 to 2.0 centimeters and a length of about 7.0 to 8.0 centimeters. In one class of this embodiment, the wells have a diameter of about 1.3 centimeter and a length of about 7.5 centimeters.

The standard heat block is designed to fit flush with standard dry block heaters. However, the heat block used with the apparatus of the present invention does not fit flush with the standard dry block heater because the heat block is designed to substantially enclose standard tubes such as the 5 milliliter cryovial. As a result, the heat block when placed in a standard dry block heater has exposed sides. Therefore, the heat block of the present invention uses an insulating collar to prevent heat loss from the exposed sides of the heat block.

The insulating collar can be made of any insulating material. However, if the insulating collar is to be used in a sterile environment such as a class 100 area, the insulating material must be nonporous and cleanable. Suitable insulating materials include a polyoxymethylene polymer such as DELRIN®, a polyether ether ketone (PEEK™) polymer such as VICTREX® PEEK™, a polytetrafluorethylene polymer such as TEFLON®, and a polyetherimide polymer such as ULTEM®.

In one embodiment of the present invention, the insulating collar comprises an insulating polymer. In a class of this embodiment, the insulating polymer comprises a polyoxymethylene polymer, a polyether ether ketone polymer, a polytetrafluorethylene polymer, a polyetherimide polymer, or blends thereof In a subclass of this class, the insulating polymer comprises a polyoxymethylene polymer. In a subclass of this class, the insulating polymer comprises a polyether ether ketone polymer. In another subclass of this class, the insulating polymer comprises a polytetrafluoroethylene polymer.

The insulating collar as described in FIG. 1 is rectangular in shape to fit the sides of the heat block. However, the insulating collar can have other suitable dimensions depending on the shape of the heating block. Additionally, the outer dimensions can be in other suitable shapes (i.e., circular or irregular).

In one embodiment of the present invention, the insulating collar has height of about 2.0 to 8.0 centimeters, an outer length of about 15.0 to 30.0 centimeters, an outer width of about 10.0 to 25.0 centimeters, an inner length of about 10.0 to 25 centimeters, and an inner width of about 5.0 to 20.0 centimeters.

In one class of this embodiment, the insulating collar has a height of about 3.30 centimeters, an outer length of about 20.32 centimeters, an outer width of about 15.24 centimeters, an inner length of about 15.16 centimeters, and an inner width of about 9.77 centimeters.

The bottom surface of the heat block has a bore that extends into the heat block to accommodate a thermocouple. The dry block heater uses the thermocouple to read the temperature of the heat block, and it turns on the heating coils of the dry block heater as necessary to heat the heat block to the desired temperature.

In one embodiment of the present invention, the bore is adapted to fit a thermocouple. In one class of this embodiment, the bore has a diameter of about 0.5 to 0.7 centimeter, and a length of about 2.0 to 3.5 centimeters. In a subclass of this class, the bore has a diameter of about 0.6 centimeter and a length of about 2.7 centimeter.

In one embodiment of the present invention, the bore is located on the bottom surface of the heat block. In one class of this embodiment, the bore is located about 3.85 centimeters from the center of the bottom surface of the heat block.

In one embodiment of the present invention, the apparatus comprises a heat block comprising a heat conductive material which is a metal alloy, the heat block having from one to twenty wells adapted to receive tubes containing samples of material; a bore on the bottom surface of the heat block adapted to receive a thermocouple; and the insulating collar comprising an insulating polymer.

In one class of this embodiment, the heat block has one well, five wells, or twenty wells. In a class of this embodiment, the heat block has one well. In another class of this embodiment, the heat block has five wells. In yet another class of this embodiment, the heat block has twenty wells.

In one class of this embodiment, the metal alloy comprises aluminum. In a class of this embodiment, the metal alloy comprises about 94.0 to 99.0 weight percent aluminum, about 0.5 to 2.0 weight percent magnesium, about 0.01 to 0.5 weight percent chromium, about 0.05 to 0.5 weight percent copper, and about 0.05 to 1.0 weight percent silicon. In a subclass of this class, the metal alloy is aluminum 6061.

In one class of this embodiment, the insulating polymer comprises a polyoxymethylene polymer, a polyether ether ketone polymer, a polytetrafluorethylene, a polyetherimide polymer, or blends thereof In a subclass of this class, the insulating polymer comprises a polyoxymethylene polymer. In a subclass of this class, the insulating polymer comprises a polyether ether ketone polymer. In another subclass of this class, the insulating polymer comprises a polytetrafluoroethylene polymer.

In one embodiment of the present invention, the apparatus comprises:

(a) a heat block having a plurality of wells adapted to receive tubes containing samples of material, wherein the heat block has a length of about 10 to 25 centimeters, a width of about 5 to about 20 centimeters, and a height of about 5 to 15 centimeters;

(b) a bore adapted to receive a thermocouple, wherein the bore has a diameter of about 0.6 centimeter and a length of about 2.7 centimeter, and the bore is located at 3.85 centimeters from the center of the block; and

(c) an insulating collar comprises a polymer, wherein the insulating collar is rectangular in shape and has a height of about 2.0 to 8.0 centimeters, an outer length of about 15.0 to 30.0 centimeters, an outer width of about 10.0 to 25.0 centimeters, an inner length of about 10.0 to 25 centimeters, and an inner width of about 5.0 to 20.0 centimeters.

In one class of this embodiment, the heat block has a length of about 15.16 centimeters, a width of about 9.76 centimeters, and a height of about 8.26 centimeters; and the insulating collar has a height of about 3.30 centimeters, an outer length of about 20.32 centimeters, an outer width of about 15.24 centimeters, an inner length of about 15.16 centimeters, and an inner width of about 9.77 centimeters.

In one class of this embodiment, the heat block has one, five, or twenty wells.

In one class of this embodiment, the heat block has one well. In one subclass of this class, the well is in the center of the top surface of the heat block.

In one class of this embodiment, the heat block has five wells.

In one subclass of this class, the five wells are arranged on the top surface of the heat block to allow for the maximum amount of conductive material between each well to maximize the heat transfer between the heat block and the tubes containing the material.

In one subclass of this class, the five wells are arranged on the top surface of the heat block in three rows, wherein one row has one well which is placed in the center of the top surface of the heat block, and wherein the other two rows each have two wells which are spaced about 10.75 centimeters, and wherein each of the wells in the other two rows are spaced by about 4.9 centimeters from the well in the center.

In yet another class of this embodiment, the heat block has twenty wells.

In one subclass of this class, the twenty wells are arranged on the top surface of the heat block to allow for the maximum amount of conductive material between each well to maximize the heat transfer between the heat block and the tubes containing the material.

In one subclass of this class, the twenty wells are arranged on the top surface of the heat block in four staggered rows of five, wherein the space between each well within each row is about 1.3 centimeter, and wherein the space between each well and the nearest well in the adjacent rows is about 2.24 centimeters.

Thus, an improved apparatus for heating sample tubes has been shown. Although specific embodiments have been illustrated and described, it will be obvious to those skilled in the art that various modifications may be made without departing from the spirit of the invention, which is intended to be limited solely by the appended claims.

What is claimed is:

1. An apparatus, comprising a heat block having a plurality of wells adapted to receive tubes containing samples of material; a bore adapted to receive a thermocouple; and an insulating collar.

2. The apparatus of claim 1, wherein the heat block comprises a metal alloy.

3. The apparatus of claim 2, wherein the metal alloy comprises aluminum.

4. The apparatus of claim 2, wherein the metal alloy comprises about 94.0 to 99.0 weight percent aluminum, about 0.5 to 2.0 weight percent magnesium, about 0.01 to 0.5 weight percent chromium, about 0.05 to 0.5 weight percent copper, and about 0.05 to 1.0 weight percent silicon.

5. The apparatus of claim 1, wherein the heat block has from one to twenty wells.

6. The apparatus of claim 5, wherein the heat block has one well.

7. The apparatus of claim 5, wherein the heat block has five wells.

8. The apparatus of claim 5, wherein the heat block has twenty wells.

9. The apparatus of claim 1, wherein the insulating collar comprises an insulating polymer.

10. The apparatus of claim 9, wherein the insulating polymer comprises a polyoxymethylene polymer, a polyether ether ketone polymer, a polytetrafluorethylene polymer, a polyetherimide polymer, or blends thereof

11. The apparatus of claim 10, wherein the insulating polymer comprises a polyoxymethylene polymer.

12. An apparatus comprising:
(a) a heat block having a plurality of wells adapted to receive tubes containing samples of material, wherein the heat block has a length of about 10 to 25 centimeters, a width of about 5 to about 20 centimeters, and a height of about 5 to 15 centimeters;
(b) a bore adapted to receive a thermocouple, wherein the bore has a diameter of about 0.6 centimeter and a length of about 2.7 centimeter, and the bore is located at 3.85 centimeters from the center of the block; and
(c) an insulating collar comprises a polymer, wherein the insulating collar is rectangular in shape and has a height of about 2.0 to 8.0 centimeters, an outer length of about 15.0 to 30.0 centimeters, an outer width of about 10.0 to 25.0 centimeters, an inner length of about 10.0 to 25 centimeters, and an inner width of about 5.0 to 20.0 centimeters.

13. The apparatus of claim 12, wherein the heat block has one well which is placed in the center of the top surface of the heat block.

14. The apparatus of claim 12, wherein the heat block has five wells, wherein the five wells are arranged on the top surface of the heat block to allow for the maximum amount of conductive material between each well to maximize the heat transfer between the heat block and the tubes containing the material.

15. The apparatus of claim 12, wherein the heat block has twenty wells, wherein the twenty wells are arranged on the top surface of the heat block to allow for the maximum amount of conductive material between each well to maximize the heat transfer between the heat block and the tubes containing the material.
